(19) United States
(12) Patent Application Publication
(10) Pub. No.: US 2011/0256449 A1
(43) Pub. Date: Oct. 20, 2011

(54) ORGANIC COATED FINE PARTICLE POWDERS

(75) Inventor: Zhenhua MAO, Ponca City, OK (US)

(73) Assignee: ConocoPhillips Company, Houston, TX (US)

(21) Appl. No.: 13/018,954

(22) Filed: Feb. 1, 2011

Related U.S. Application Data
(60) Provisional application No. 61/325,458, filed on Apr. 19, 2010.

(51) Int. Cl. H01M 4/60; B05D 1/18; B05D 3/00; B05D 7/24; B05D 5/12

(52) U.S. Cl. 429/213; 427/212; 427/122

(57) ABSTRACT

Solid organic matter coated fine solid particles and the applications of such coated particles are described. These uniformly coated carbonaceous particles provide an improved material for use as an electrochemical material. In one example, methods of manufacturing uniformly coated particles from lignin and graphite are described. In another embodiment, petroleum pitch coated calcined coke powder is demonstrated.

### CROSS-REFERENCE TO RELATED APPLICATIONS

This application is a non-provisional application which claims benefit under 35 USC §119(e) to U.S. Provisional Application Ser. No. 61/325,458 filed Apr. 19, 2010, entitled “ORGANIC MATTER COATED FINE PARTICLES,” which is incorporated herein in its entirety.

### STATEMENT REGARDING FEDERALLY SPONSORED RESEARCH

None.

### FIELD OF THE INVENTION

This invention is related to a process or method for making organic matter coated fine solid particles and the applications of such coated particles.

### BACKGROUND OF THE INVENTION

Solid organic matter coated solid particles are useful as functional materials for various industry applications. Particularly, carbonaceous material coated fine graphite particles and lithium iron phosphate particles can be used as anode and cathode materials for lithium ion batteries. There are various methods for coating carbonaceous materials on fine particles such as vapor phase chemical deposition, mechanical blending, and liquid phase precipitation, however, these methods have certain limitations such as slow coating process, poor coating quality, and lack of the flexibility for selection of coating materials. A flexible and effective method is needed for coating various solid organic materials on solid particles so that fine particles with desirable properties for different industry applications can be economically manufactured.

Synthetic graphite powders are widely used as negative electrode materials in lithium ion batteries. Other carbonaceous materials are also widely used in such batteries due to their efficiency and reasonable cost. Lithium ion batteries are primarily used as power sources in portable electronic devices. Compared to other classes of rechargeable batteries such as nickel-cadmium and nickel-metal hydride storage cells, lithium ion cells have become increasingly popular due to relatively high storage capacity and rechargeability.

Due to increased storage capacity per unit mass or unit volume over similarly rated nickel-cadmium and nickel-metal hydride storage cells, the smaller space requirements of lithium ion cells allow production of cells that meet specific storage and delivery requirements. Consequently, lithium ion cells are popularly used in a growing number of devices, such as digital cameras, digital video recorders, computers, etc., where compact size is particularly desirable from a utility standpoint.

Nonetheless, rechargeable lithium ion storage cells are not without deficiencies. These deficiencies may be minimized with the use of improved materials of construction. Commercial lithium ion batteries which use synthetic graphite electrodes are expensive to produce and have relatively low lithium capacities. Additionally, graphite products currently used in lithium ion electrodes are near their theoretical limits for energy storage (372 mAhr/g). Accordingly, there is a need in the art for improved electrode materials that reduce the cost of rechargeable lithium batteries and provide improved operating characteristics, such as higher energy density, greater reversible capacity and greater initial charge efficiency. There also exists a need for improved methods for the manufacture of such electrode materials.

Silicon has been investigated as an anode material for lithium ion batteries because silicon can alloy with a relatively large amount of lithium, providing greater storage capacity. In fact, silicon has a theoretical lithium capacity of more than ten times that of graphite. However, pure silicon is a poor electrode material because its unit cell volume can increase to more than 300% when lithiated. This volume expansion during cycling destroys the mechanical integrity of the electrode and leads to a rapid capacity loss during battery cycling. Although silicon can hold more lithium than carbon, when lithium is introduced to silicon, the silicon disintegrates and results in less electrical contact which ultimately results in decreased ability to recharge the storage cell.

Mao, et al., U.S. Pat. No. 5,972,537, describe pyrolysis of lignin, purification of the pyrolyzed carbon produced, and use of the pyrolyzed carbons as a negative electrode. The pyrolyzed lignin produced a fine powder containing amorphous carbon after pyrolysis that required further purification to remove impurities. The fine carbon powder provided an unstructured carbon powder as electrochemical material for a negative electrode.

Continuous research efforts in solving silicon volume expansion problems have yielded limited results. Silicon/carbon composite particles or powders have good cycle life compared to mechanical mixtures of carbon and silicon powders made by milling or other mechanical methods. Thin film silicon-coated carbon particles or carbon-coated silicon powders are potential replacements for graphite powders as the anode material for next generation lithium ion batteries. However, chemical vapor deposition methods typically used to apply silicon coatings or carbon coatings have intrinsic shortcomings that include slow deposition rates and/or expensive precursors for deposition. Vapor deposited silicon films may be extremely expensive relative to the cost of bulk silicon powders. Therefore, another method of manufacturing coated silicon particles is needed.

### BRIEF SUMMARY OF THE DISCLOSURE

An improved material for use as an electrochemical material is described including methods of manufacturing that material from lignin coated graphite.

In one embodiment, solid heavy hydrocarbon-coated particles are prepared as described where a large hydrocarbon compound or large hydrocarbon compound mixture is dissolved in two organic solvents to form solution B and heating solution B; solid particles to be coated are dispersed in a second solvent to form mixture C and heating the mixture C, solution B and mixture C are mixed together and cooled causing all or a certain portion of the large hydrocarbon compound or large hydrocarbon compound mixture to precipitate out as a coating on the solid particles, the coated solid particles are separated from the solution; and carbonized.

In another embodiment an electrochemical material for an electrode is made from graphite particles and lignin coating by dispersing the graphite in xylene, dissolving the lignin in pitch and xylene, mixing the graphite-xylene solution and the lignin-pitch-xylene solution, and uniformly coating graphite with lignin.

Additionally, an electrochemical material for an electrode can be made by mixing lignin with pitch, mixing the lignin and pitch with xylene, dispersing graphite particles in xylene, heating the solution and the mixture to boiling point, mixing the solution and the mixture at boiling point, and to produce isolated graphite particles uniformly coated with lignin.

Alternatively graphite particles uniformly coated with lignin can be prepared by:

a) dissolving lignin in pitch,

b) mixing the lignin and pitch (a) with xylene,

c) dispersing graphite particles in xylene,

d) heating the solution from step (b) and the mixture from step (c) to boiling point,

e) mixing the solution from step (b) and the mixture from step (c) at boiling point, and

f) isolating graphite particles uniformly coated with lignin.

Heavy hydrocarbons include organic compounds and mixtures such as lignin, phenol resins, natural resinous polymers, lignins, polymeric olefins, synthetic polymers, acrylates, polyethylenes, and combinations thereof containing two or more different long chain hydrocarbons. Organic compound mixtures used to dissolve heavy hydrocarbons include fractionated petroleum, fractionated decant oils, pyrolysis tars, petroleum pitches, coal tar pitches and heavy petroleum oils. Solid particles and useful carbonaceous materials include petroleum and coal cokes and synthetic and natural graphite. Useful solvents in preparing mixtures B and C can be one of many liquid organic compounds including xylene, toluene, benzenes, tetralin, methyl-pyrrolidinone, quinoline, petroleum distillates and combinations thereof.

Heavy hydrocarbons may be completely or nearly completely dissolved in the solvent. In one embodiment, the first solvent is completely soluble in the second solvent. The first solvent may be completely soluble when the ratio of the second solvent to the first one is less than 1. After mixing, the overall mass ratio of the second solvent to the first solvents can be greater than 2 Solution B, mixture C, or both solution B and mixture C may be heated near the boiling point of one or more of the solvents prior to or during mixing of solution B and mixture C. The coated particles may be carbonized in some instances above 400° C. in inert environment such as nitrogen gas. After being generated, the uniformly coated particles can subsequently carbonized, chemically modified, plated with metal or combinations of one or more treatments. A variety of techniques may be used to incorporate the carbonaceous material coated particles into an electrode of an electrochemical energy cell.

In one embodiment lignin, pitch and xylene were mixed at an approximately 1:10:5 ratio to generate solution B. Graphite and xylene may be mixed at an approximately 2:9 ratio to generate mixture C. Solutions B and C may be mixed at a variety of ratios to achieve different amounts of uniform coating, in one embodiment, they were mixed at an approximately 1:10 ratio.

### BRIEF DESCRIPTION OF THE DRAWINGS

A more complete understanding of the present invention and benefits thereof may be acquired by referring to the follow description taken in conjunction with the accompanying drawings in which:

FIG. 1: Diagram for organic coated fine solid particles.

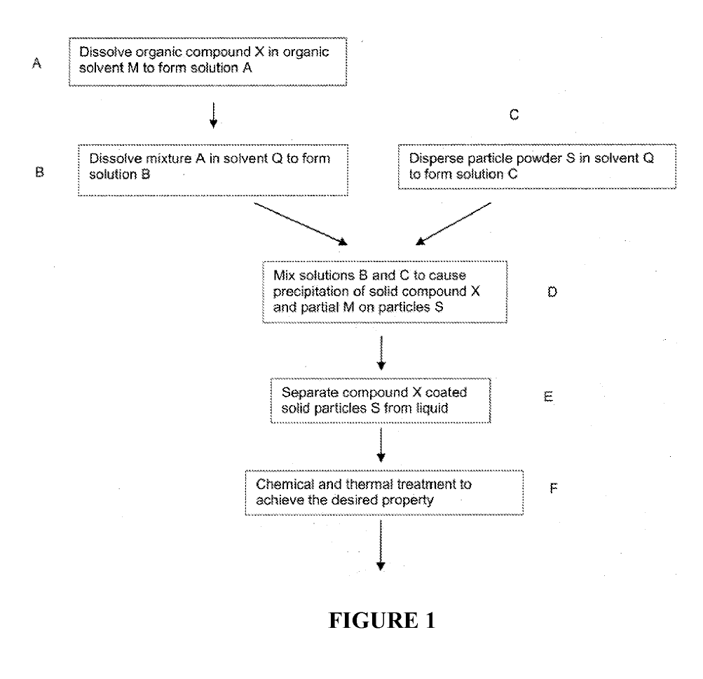

FIG. 2: Comparison of scanning electron microscopy (SEM) micrographs for the graphite particles: (a) uncoated, (b) coated in Example 1, and (c) coated in Example 2

FIG. 3: Comparison of scanning electron microscopy (SEM) micrographs for the coke particles: (a) uncoated, (b) coated in Example 3, and (c) coated in Comparison Example 3

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Previously, Mills, U.S. Pat. No. 4,308,073, describes mixing graphite and carbon black which is subsequently mixed with liquid pelleting medium, the wet mixture is formed into pellets and the wet pellets are dried. Mao and Carel, US20070092429, described a method for the production of carbon-coated particles by coating a milled carbonaceous material and thermal-conditioning of the carbon material. Mao and Carel produced graphitic-structured carbon-coated particles with an average particle size of less than about 30 μm with an aspect ratio of less than about 4 and a carbonaceous coating level of from about 1% to about 50% by weight.

A process or method for making fine solid particles coated with organic solid, and the applications of such coated particles.
Step A: organic compound X is completely or almost completely dissolved in organic Solvent M to form mixture or Solution A.
Step B: solution A is mixed with solvent Q to form Solution (or slurry) B.
Step C: solid particles (to be coated) are dispersed in Solvent Q to form Solution C through mechanical agitation.
Step D: Solutions B and C are mixed to cause precipitation of all or partial Compound X on solid particles S.
Step E: Compound X-coated particles are obtained by mechanical filtration.
   Where compound X is completely or almost completely soluble in Solvent M, but much less soluble in the organic Solvent Q or contains a certain amount of mass that is insoluble in the organic solvent Q in Step B. Solvent M is chosen from aromatic hydrocarbon mixtures including petroleum refinery residues such as decant oils, vacuum residues, pitches and coal tar pitches, can be either in liquid or solid form at ambient temperature (but becomes liquid at an elevated temperature), and is completely soluble in solvent Q. In some embodiments, the light portion of compound X is used as solvent M

Mixing or compounding can be done through mechanical blending at ambient or an elevated temperature so that organic compound X is completely or almost completely dissolved in the solvent. In this solution, both Solvent M and Compound X remain completely or almost completely dissolved. In one embodiment, Steps A and B are merged into one step. Optionally, solvent Q can be pre-mixed with solvent M, and organic compound X is subsequently dissolved in the solvent mixture to form solution B. In one embodiment, mixing is by mechanical agitation at an elevated temperature. After Step D at elevated temperature, the solution is cooled to ambient temperature. The physical and chemical property of the compound X coated particles can be modified by chemical and thermal treatment at subsequent steps. Different hydrocarbon compounds can be coated on solid particles to create the required properties to suit for different applications.

The first step (step A) is to mix or compound a desired organic compound X with organic solvent M to form mixture or solution A. The desired organic compound X is the material that is to be coated on solid particles in the subsequent step, as described below. This material should be completely or almost completely soluble with solvent M when they are mixed together within a certain proportion, but is much less soluble in the organic solvent Q in Step B. The so-called “solvent” M is chosen from hydrocarbon mixtures such as petroleum and coal tar pitches, can be either in liquid or solid form at ambient temperature, but becomes liquid at an elevated temperature, and is completely soluble in solvent Q. Mixing or compounding can be done through mechanical blending at ambient or an elevated temperature.

The operation in Step B involves mixing solution A with solvent Q to form solution or slurry B. In this solution, both organic solvent M and organic compound X remain dissolved or at least partially dissolved. Preferably, Steps A and B can be merged into one step. That is, organic compound X, solvent M and solvent Q can be mixed at one step to form a solution or slurry. Step C is to disperse solid particles in solvent Q to form solution C through mechanical agitation. Step D is to mix solutions B and C to cause precipitation of organic compound X and partial solvent M on solid particles S. The resulting solid particles consist of core particle S and organic compound X film or ultra fine particles on surface of particles S. Mixing can be done through mechanical agitation at an elevated temperature, and subsequently cooled to ambient temperature.

As used herein, compound X is a large hydrocarbon compound or large hydrocarbon compound mixture. Large hydrocarbon compound or large hydrocarbon compound mixture s include a variety of natural resinous polymers, lignins, and synthetic polymers such as polyacrylates, polyethylenes, polyvinyl alcohols, polyvinyl halides, polyvinyl nitriles, polyvinyl esters, polystyrene, polyacetylene, polyacrylics, polyvinyl ethers, and the like, combinations thereof containing two or more different long chain hydrocarbons.

In one embodiment, solid particles of carbonaceous substrate material may be obtained from a variety of sources, examples of which include petroleum and coal tar cokes, synthetic and natural graphite, or pitches as well as other sources of carbonaceous materials that are known in the manufacture of carbon and graphite materials. Sources of carbonaceous materials include calcined or uncalcined petroleum cokes, synthetic graphite, highly crystalline “needle” cokes, natural graphite and flake coke. Thus, preferred carbonaceous materials are either graphitic materials or materials which form graphite on heating to graphitization temperatures of approximately 2200° C. or higher.

In another embodiment, solid particles may be chosen from other solid inorganic materials including metals, metal alloys, metal and non-metal oxides, lithium metal polyanion compounds, and metal salts.

Suitable solvents (solvent Q) for dissolving the organic compound X and the first solvent M include, e.g., benzene, toluene, xylene, quinoline, tetrahydrofuran, naphthalene, acetone, cyclohexane, and tetrahydronaphthalene (sold by DUPONT© under the trademark TETRALIN®), ether, water and methyl-pyrrolidinone, etc. When petroleum or coal tar pitch is used as the carbon residue-forming material or coating material, solvents such as toluene, xylene, quinoline, tetrahydrofuran, TETRALIN®, or naphthalene may be used. The ratio of the solvent(s) to carbon residue-forming material and the temperature of the solution is controlled to ensure the carbon residue-forming material completely or almost completely dissolves into the solvent. In one embodiment, the solvent to carbon residue-forming material ratio is less than about 2, less than about 1.75, less than about 1.5, less than about 1.25, less than about 1, less than about 0.75, less than about 0.5, less than about 0.25, or less, and the carbon residue-forming material is dissolved in the solvent at a temperature that is below the boiling point of the solvent.

Concentrated solutions (Solution A) wherein the solvent-to-solute ratio is less than 2:1 are commonly known as flux solutions. Many pitch-type materials form concentrated flux solutions wherein the pitch is highly soluble when mixed with the solvent at solvent-to-pitch ratios of 0.5 to 2.0. Dilution of these flux mixtures with the same solvent or a solvent in which the carbon residue-forming material is less soluble results in partial precipitation of the carbon residue-forming material. When this dilution and precipitation occurs in the presence of a suspension of solid particles, the particles act as nucleating sites for the precipitation. The result is an especially uniform coating of the organic compound on the solid particles.

As used herein organic compound X or coating precursor includes organic polymers and polymer mixtures such as petroleum and coal tar pitches, pyrolysis tars, petroleum refinery residues, fractionated decant oils, lignin, phenol resins, polyacrylonitrile, cellulose, polyamine, and anthracene tars, etc.

As used herein pitch includes Ashland A240, graphite grade pitch, impregnation pitch, liquid pitch, granulated pitch, petroleum pitch, tall oil pitch, coal tar, coal-tar pitch, coal extracts, coal tar distillates, binding pitch, mineral tar, mineral pitch, as well as similar carbon containing tars and pitches derived from a variety of carbon sources. Pitches may be blended with a variety of diluents, solvents, cokes, or other materials to increase or decrease the viscosity of the blend and/or change the relative concentrations of different carbon materials. Pitch blends can be targeted for viscosities ranging anywhere from about 300 cs to about 1000 cs. In one embodiment the pitch is blended to between about 500 cs and about 700 cs. Often pitch is about 600 cs+/−100 cs. Pitch viscosity can also be modulated by increasing or decreasing the overall temperature of the pitch. At or below approximately 35 to 55° C. (100 to 125° F.) the pitch may thicken, while at or above approximately 80 to 95° C. (175 to 200° F.) the pitch composition may undergo chemical changes or separate. Although the pitch can be maintained between temperatures of approximately 35 to 95° C. to achieve a less viscous material, it may be stored at less than 35° C. and used at above 95° C. A variety of pitches, tars and tar-pitches are commercially available from suppliers around the world, including PARCHEM™ Trading Ltd., KOPPERS™ Inc., Boise Int'l Holdings Ltd., Jalan Carbons & Chemicals Ltd., Nangalia Hydrocarbon Ltd., Shandong Gude Chemistry Co., CEL TRILLIUM™ Trade Inc., Kadel Trading LLC, Yaren Grup Ltd., and other suppliers. Alternatively, tars, pitches, cokes, and carbon products of various densities are frequently produced during the refining process. Tars and pitches having a variety of viscosities and different compositions are available as waste products, alternatively high grade cokes, tars, and pitches are generated through specialized refining processes.

There are several types of lignin defined by relatively small variations in the chemical structure. The chief distinctions between lignins are: hard wood lignin versus soft wood lignin; the type of chemical pulping used to remove the lignin from raw wood; and subsequent chemical modifications. The degree of oxidation and/or degradation of the obtained lignins varies with the choice of the pulping process. Indeed, lignin exhibits slow, spontaneous oxidation and degradation even upon prolonged exposure to air. However, lignin products from the various pulping methods are substantially similar for purposes of carbon formation as described herein. A variety of lignins are available through commercial suppliers including BORREGAARD™, SIGMA™, FISCHER™, and as a byproduct of paper production available from most paper mills.

The solubility of the organic compound X or the carbon residue-forming materials in a given solvent or solvent mixture depends on a variety of factors including, for example, concentration, temperature, and pressure. As stated earlier, dilution of concentrated flux solutions causes solubility to decrease since the solubility of the carbon residue-forming material in an organic solvent increases with temperature, precipitation of the coating is further enhanced by starting the process at an elevated temperature and gradually lowering the temperature during the coating process. The carbon residue-forming material can be deposited at either ambient or reduced pressure and at a temperature of between about −5° C. to about 400° C. By adjusting the total ratio of the solvent to the carbon residue-forming material and the solution temperature, the total amount and hardness of the precipitated carbon residue-forming material on the solid particles can be controlled.

All the processes may be carried out under atmospheric conditions unless otherwise specified. For carbonization atmospheric conditions with ambient air are typically used up to about 850° C. An inert atmosphere may be used at temperatures above about 400° C. Suitable inert atmospheres include nitrogen, argon, helium, and other gases which are non-reactive with the reaction conditions at the time.

Carbonization for the particles coated with the carbon residue-forming material may be used to increase the carbon content of the coating material and core particles. This may be achieved by raising the temperature in a controlled manner from a starting temperature, usually ambient temperature, to the final carbonization temperature which may be about 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., or about 1500° C. with a range of about 50, 100 or even 200° C. of the median temperature. Frequently, temperatures are raised to within various ranges dependent upon the size and properties of the particles, from about 400° C. to about 1500° C., alternatively within the range of about 800° C. to about 1300° C., or within the range of about 900° C. and 1200° C.

Upon completion of the precipitation step, the coated particles are separated from the mixture of solvents, particles, and carbon residue-forming material using conventional methods, such as filtration, decantation, centrifugation, evaporation, crystallization, distillation, or other known separation techniques. In one embodiment, the particles are filtered and washed with solvent to remove residual pitch (or other carbon forming residues) solution and dried using conventional methods.

The following examples of certain embodiments of the invention are given. Each example is provided by way of explanation of the invention, one of many embodiments of the invention, and the following examples should not be read to limit, or define, the scope of the invention.

### Example 1

This example illustrates that lignin coated of graphite particles through the use of petroleum pitch as a first solvent M and xylene as a second solvent Q. A Kraft lignin, as provided by Westvaco Corp. or available from a number of other commercial sources, does not dissolve in nonpolar solvents such as xylene but will dissolve completely in polar solvents such as water and N-methyl pyrrolidinone (NMP). Lignins cannot be uniformly coated on fine graphite particles with any known method including previous ConocoPhillips pitch coating methods because the graphite particles and lignins are not compatible. However, the lignin is at least partially soluble in petroleum pitches such as Ashland A240 pitch, and pitch is completely soluble with xylene when the ratio of pitch to xylene is greater than 1. Therefore, a solution of pitch and lignin is at least partially soluble in xylene when the ratio of pitch with lignin to xylene is greater than 1. Lignin will then precipitate out as the content of xylene is increased.

In one embodiment graphite particles were coated with lignin through dissolution in pitch. Initially, 0.71 grams of lignin were dissolved in 10 grams of pitch and the lignin-pitch mixture dissolved in 5 grams of xylene. The solution was shaken for approximately 30 minutes in a mixer. The resulting solution was smooth and lump free by visual observation, and was labeled as “Solution B.” Spherical natural graphite powder, 20 grams, was dispersed in 90 grams of xylene to form “Solution C.” Solution B was heated in a water bath up to approximately 95° C., and solution C was heated up to its boiling point of approximately 140° C. While solution C was continuously stirred at boiling point, solution B was rapidly added. The mixture was kept at boiling point and stirred for 10 minutes, the heat source was removed and the solution was cooled to ambient temperature. The resulting solid powder was obtained by filtration and washed thoroughly with xylene, and subsequently dried at 85° C. under vacuum for 12 hours. The resulting dry powder weighed 21.86 g, yielding 1.15 grams of the coating solid with 0.71 grams from lignin. The total coating level was 8.5% by weight.

In this embodiment, lignin was premixed with pitch and then xylene at a 1:10:5 ratio (Solution B). Graphite particles were dispersed in xylene at a 2:9 ratio (Solution C). Solution B and solution C were heated to boiling point. Finally, B and C were mixed at approximately 1:10 ratio. The resulting graphite particles were uniformly coated with lignin and dried to yield nearly 100% product (20 g graphite).

### Example 2

In this example, 2 grams of lignin were dissolved as previously described in pitch, then in xylene at a 1:10:5 ratio. A graphite solution was prepared by dispersing 20 grams of graphite particles in xylene at a 2:9 ratio. The lignin solution (B) was mixed with the graphite solution (C) at boiling temperature. After filtration, washing, and drying, the total solid weighed 23.1 grams, giving a nearly 100% yield as described in Example 1 incorporating all the lignin, 2.0 grams. In this case, the total coating level was 13.4% by weight.

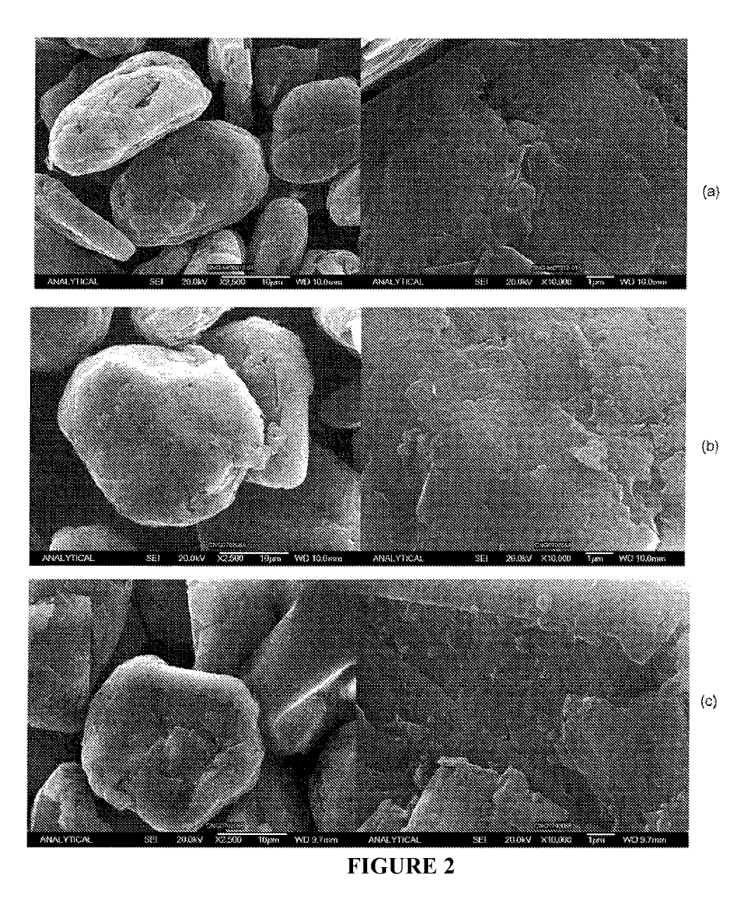

In FIG. 2, a comparison of the particles shows differences in morphologies of scanning electron microscopy (SEM) between uncoated particles and the coated particles from Examples 1 and 2. The uncoated particles show clean sharp edges and kinks on the surface, whereas the coated particles exhibit not only round edges and filled gaps between kinks but also fine particles on the surfaces. It should be noted that there were few if any free fine particles in either example 1 or 2. This confirms that a uniform lignin film was coated on the graphite particles in both the examples. It is worth mentioning that lignin does not dissolve in xylene, as a result, lignin can't be coated on graphite particles by simply mixing lignin, xylene and graphite particles together or by simply adjusting temperature and the ratio of the components, but through dissolution in pitch and precipitation from the pitch-xylene solution as xylene concentrations are increased, the lignin forms a uniform film of very fine particles to adhere evenly to the graphite particles.

After a uniform lignin coating is achieved, the coated graphite can be further processed to increase graphitic properties, attach active moieties, and add additional layers to the coated particles. In some embodiments the lignin coated particles are carbonized by raising the temperature. In other embodiments the particles are charged with an acidic or basic moiety to impart a chemical property over the lignin coating. In yet another embodiment, the particles are plated with a conductive metal, rare earth magnet, or other metal. The presence of the uniform lignin coating allows the graphite particles to be consistently and completely coated using a variety of techniques because the lignin properties are the same across the particle surfaces.

### Example 3

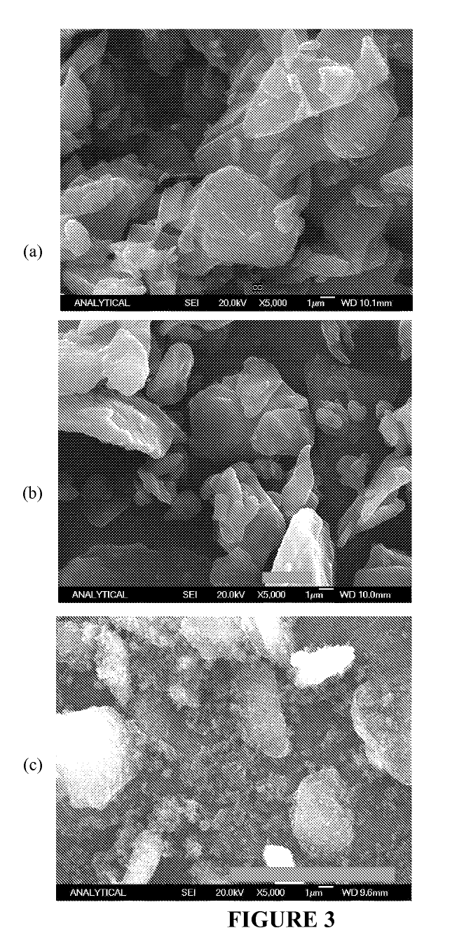

In yet another embodiment, 100 grams of a petroleum pitch were dissolved in 100 grams of a petroleum decant oil to form a solution, and subsequently the resulting solution was then mixed 50 grams of xylene and heated to 140° C. under continuous agitation to form solution B. In parallel, 200 gram of a calcined petroleum coke powder (average particle size of about 8 micrometers were dispersed in 500 grams of xylene in a flask and also heated to the boiling point of xylene (˜140° C.), to make solution C. The hot pitch solution B was then poured into the coke solution C and mixed for about 5 minutes under continuous agitation. The heat was removed and the solution was cooled to ambient temperature. The resulting solid particles were separated from the solution by filtration and washed thoroughly with xylene. After drying at 100° C. under vacuum for 5 hours, the resulting solid particles weighed 223 grams. Thus, the resulting solid particles contained about 10% solid xylene-insoluble pitch. Under an electron-scanning microscope, FIG. 3 (a), it was found that the solid xylene-insoluble pitch uniformly coated the coke particles.

Example 3 was repeated as described above except the petroleum decant oil was not used in preparing solution A. It was found that the same amount of solid xylene-insoluble pitch precipitated out from the solution but did not form uniform coating on coke particles, instead very fine particles were formed that did not adhere to the petroleum coke, FIG. 3 (c).

### Example 4

By choosing the right solvent combinations, this method of coating can be accomplished with a variety of coatings on a variety of particle types. Table 1 provides a different coating, solvent, and particle combinations that can achieve uniform particle coating with large hydrocarbon compound or large hydrocarbon compound mixture s on graphite, metal, and heavy hydrocarbon particles. In the right combination, the coating polymer, compound X, is nearly or completely soluble in a solvent M to generate solution A, solution A is dissolved in solvent Q₁ to make solution B. The solid particle to be coated is dispersed in either solvent Q₁ to make solution C. Solution B and solution C are mixed, causing the dissolved polymer compound X to precipitate and simultaneously coat the solid particle.

TABLE 1
Polymer coated electrochemical particles

| Polymer | Solvent M | Solvent Q₁ | Solid Particle |
|---|---|---|---|
| Lignin | Pitch | Xylene | Graphite |
| Lignin | A240 Pitch | Xylene | Graphite |
| Petroleum Pitch | petroleum refinery hydro | Xylene | Calcined petroleum coke |
| | cracking tar | | powder |
| Polyvinyl Chloride | Light coal pyrolysis | Benzene | Carbon powder |
| (PVC) | residue | | |
| Polyacrylonitrile | Petroleum refinery | Toluene | Metal particles |
| | residual | | |
| Polyurethane | Light ethylene pyrolysis | Xylene | Carbonaceous particles |
| | residue | | |
| Epoxies | Petroleum refinery residue | Quinoline | Carbonaceous particles |
| Phenoliecs | Light petroleum refinery | Tetrahydrofuran (THF) | Carbonaceous powders |
| | residues | | |
| Polyimide | Petroleum decant oil | Naphthalene | Carbonaceous particle |
| Fractionated isotropic | Light petroleum refinery | Benzene | Inorganic salts |
| pitch | residue | | |
| Fractionated | Petroleum refinery | Cyclohexane | Metal oxide |
| petroleum pitches | vacuum residue | | |
| Petroleum refinery | Light petroleum refinery | Tetrahydronaphthalene | non-metal solids |
| thermal cracking tars | thermal cracking tars | (TETRALIN ®) | |
| Coal pyrolysis tars | Light coal pyrolysis tar | Methyl-pyrrolidinone | Carbonaceous particles |
| Bio and renewable | Mineral oils | Xylene | Carbonaceous particles |
| fuel pyrolysis tars | | | |
| Fractionated ethylene | Petroleum refinery | Methyl-pyrrolidinone | Metal alloys |
| pyrolysis tars | vacuum residue | | |

The use of distributed or mixed solvents (M) to dissolve larger coating polymers provides a vehicle for delivery of these polymers to the solid particles. The solid particles provide nucleation for coating polymers that are precipitated out of solution with increasing concentrations of solvent Q. The final coating particle is uniformly coated with a thin layer of polymer. In one embodiment, this method allows dissolution of a typically insoluble polymer into a solution followed controlled precipitation of that polymer onto a solid particle as the concentration of inorganic solvent increases. This method can be accomplished with the materials in Table 1 by dissolving any one of the polymers into any one of the mixed solvents. In some embodiments the solvent may be heated to facilitate dissolution of the polymer into the solvent. Because the solvents are mixed solutions, the boiling point may vary and/or the temperature at which polymer nearly or completely dissolves may vary. The solvent Q listed in Table 1 may be mixed with the solid particles to ensure the particles are dispersed throughout the solvent. Subsequently, when the solvent M and the Solvent Q are mixed, the coating polymer is distributed evenly over the surface of the solid particle creating a uniform thin coating.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents. In closing, it should be noted that each and every claim below is hereby incorporated into this detailed description or specification as an additional embodiments of the present invention.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. U.S. Pat. No. 4,308,073, “Pellets of graphite and carbon black and method of producing,” Phillips Petroleum Co, Mills (1981).
2. U.S. Pat. No. 5,972,537, “Carbon electrode material for electrochemical cells and method of making same,” Motorola, Inc., Mao, et al. (1999).
3. U.S. Pat. No. 6,099,990, “Carbon electrode material for electrochemical cells and method of making same,” Motorola, Inc., Denton & Smith (2000)
4. U.S. Pat. No. 7,323,120, US2005247914, US2008090148, “Coated carbonaceous particles particularly useful as electrode materials in electrical storage cells, and method of making the same,” Conocophillips Co., Mao (2005).
5. U.S. Pat. No. 7,618,678, US20050136330, US20090130562, US20090252864, WO2005065082, “Methods of Preparing Composite Carbon-Graphite-Silicon Particles and Using Same,” Conocophillips Co., Carel and Mao, (2005)
6. U.S. Pat. No. 7,597,999, US2007286792, WO2007143388, “Methods of Preparing Carbonaceous Anode Materials and Using Same,” ConocoPhillips Co., Mao, et al., (2007).
7. US20070092429, “Methods Of Preparing Carbon-Coated Particles And Using Same,” Conocophillips Co., Mao and Carel, (2007).
8. WO9804009, “High Volumetric Capacity Electrodes And Electrochemical Cells Using Same,” Motorola, Inc., Mao, et al. (1998).
9. WO9905347, “Carbon Electrode Material For Electrochemical Cells And Method Of Making Same,” Motorola, Inc., Denton (1999).
10. Kim, et al., “Electrochemical characteristics of copper silicide-coated graphite as an anode material of lithium secondary batteries,” Electrochimica Acta 52:1532-7 (2006).
11. Micic, et al., “Visualization of artificial lignin supramolecular structures,” Scanning 22:288-94 (2000).
12. Sharif Sh., et al., “Improvement of water/resin wettability of graphite using carbon black nano particles coating via ink media,” J. Alloys Cmpd., 482:361-5 (2009).
13. “Characteristics of graphite anode modified by CVD carbon” Surface and Coatings Technology, 200:3041-8 (2006).
14. Wassel, et al., “Dispersion of super paramagnetic iron oxide nanoparticles in poly(D,L-lactide-co-glycolide) microparticles” Colloids and Surfaces A: Physicochemical and Engineering Aspects, 292:125-30 (2006).

1. A method for preparing solid heavy hydrocarbon-coated particles, comprising:
a) dissolving a large hydrocarbon compound or large hydrocarbon compound mixture in two organic solvents to form solution B and heating solution B;
b) dispersing solid particles in the second solvent to form mixture C and heating the mixture C,
c) mixing solution B and mixture C together and cooling the mixture to cause all or a certain portion of the large hydrocarbon compound mixture to precipitate out as coating on the solid particles,
d) separating the coated solid particles from the solution; and
e) carbonizing the coated solid particles to provide carbonaceous material coated particles.

2. The method according to claim 1, wherein the large hydrocarbon compounds are selected from organic compounds and mixtures including lignin, phenol resins, natural resinous polymers, lignins, polymeric olefins, synthetic polymers, acrylates, polyethylenes, and combinations thereof containing two or more different long chain hydrocarbons.

3. The method according to claim 1, wherein the first solvent in preparing mixture B is selected from organic compound mixtures including fractionated petroleum, fractionated decant oils, pyrolysis tars, petroleum and coal tar pitches, and coal tar pitches and heavy petroleum oils.

4. The method according to claim 1, wherein the one of the solvents in preparing mixtures B and C is selected from liquid organic compounds including xylene, toluene, benzenes, tetralin, methyl-pyrrolidinone, quinoline, petroleum distillates and combinations thereof.

5. The method according to claim 1, wherein the heavy hydrocarbon is completely or nearly completely dissolved in the first solvent.

6. The method according to claim 1, wherein the first solvent is completely soluble in the second solvent or completely soluble when the ratio of the second solvent to the first one is less than 1.

7. The method according to claim 1, wherein the overall mass ratio of the second to first solvents is greater than 2

8. The method according to claim 1, wherein the solid particles are carbonaceous materials include petroleum and coal cokes and synthetic and natural graphite.

9. The method according to claim 1, wherein the carbonizing includes heating the solids above 400° C. in inert environment such as nitrogen gas.

10. The method according to claim 1, further comprising incorporating the carbonaceous material coated particles into an electrode of an electrochemical energy cell.

11. The method according to claim 1, comprising heating solution B, solution C, or both solution B and C near the boiling point of one or more of the solvents.

12. An electrochemical material for an electrode comprising:
a) a graphite particle; and
b) a large hydrocarbon compound coating;
wherein said graphite particles are dispersed in xylene, said lignin is dissolved in pitch and xylene, wherein said graphite-xylene solution and said lignin-pitch-xylene solution are mixed, and wherein said graphite is uniformly coated with lignin while boiling the mixed solution.

13. The electrochemical material of claim 12, wherein the large hydrocarbon compound is selected from organic compounds and mixtures including lignin, phenol resins, natural resinous polymers, polymeric olefins, synthetic polymers, acrylates, polyethylenes, and combinations thereof containing one or more large hydrocarbon compounds.

14. The electrochemical material of claim 12, wherein the graphite particle includes petroleum and coal cokes and synthetic and natural graphite.

15. The electrochemical material of claim 12, wherein said electrochemical material is incorporated into an electrode of an electrochemical energy cell.

16. The electrochemical material of claim 12, wherein the large hydrocarbon compound, pitch and xylene were mixed at an approximately 1:10:5 ratio (Solution B).

17. The electrochemical material of claim 12, wherein the graphite and xylene were mixed at an approximately 2:9 ratio (Solution C).

18. The electrochemical material of claim 12, wherein said particles are subsequently carbonized, chemically modified, plated with metal or a combination thereof.

19. The method of producing an electrochemical material for an electrode comprising:
a) mixing lignin with pitch to form solution A,
b) mixing solution A with xylene to form solution B,
c) dissolving graphite particles in xylene to form solution C,
d) heating solution B and solution C to boiling point,
e) mixing the solution B and solution C at boiling point, and
f) isolating graphite particles uniformly coated with lignin.

20. The method according to claim 19, wherein the first solvent in preparing mixture B is selected from organic compound mixtures including fractionated petroleum, fractionated decant oils, pyrolysis tars, petroleum and coal tar pitches, and coal tar pitches and heavy petroleum oils.

21. The method according to claim 19, wherein the one of the solvents in preparing mixtures B and C is selected from liquid organic compounds including xylene, toluene, benzenes, tetralin, methyl-pyrrolidinone, quinoline, petroleum distillates and combinations thereof.

22. The method according to claim 19, wherein the lignin is completely or nearly completely dissolved in the first solvent.

23. The method according to claim 19, wherein the first solvent is completely soluble in the second solvent or completely soluble when the ratio of the second solvent to the first one is less than 1.

24. The method according to claim 19, wherein the overall mass ratio of the second to first solvents is greater than 2

25. The method according to claim 19, wherein the graphite particles are carbonaceous materials including petroleum cokes, coal cokes, synthetic graphite, natural graphite, and combinations thereof.

26. The method according to claim 19, further comprising incorporating the electrochemical material coated particles into an electrode of an electrochemical energy cell.

27. The method according to claim 19, comprising heating solution B, solution C, or both solution B and C near the boiling point of one or more of the solvents.

28. The electrochemical material of claim 19, wherein the lignin, pitch and xylene were mixed at an approximately 1:10:5 ratio (Solution B).

29. The electrochemical material of claim 19, wherein the graphite and xylene were mixed at an approximately 2:9 ratio (Solution C).

30. The g electrochemical material of claim 19, wherein solutions B and C were mixed at an approximately 1:10 ratio.

31. The electrochemical material of claim 19, wherein said particles are subsequently carbonized, chemically modified, plated with metal or a combination thereof.
